(19) United States
(12) Patent Application Publication
(10) Pub. No.: US 2009/0327873 A1
(43) Pub. Date: Dec. 31, 2009

(54) PAGE EDITING

(76) Inventor: Glen Cairns, Coquitlam (CA)

Correspondence Address: Amelia A. Buharin;Patent Legal Staff, Eastman Kodak Company, 343 State Street, Rochester, NY, 14650-2201, US

(21) Appl. No.: 12/146,698

(22) Filed: Jun. 26, 2008

(51) Int. Cl. G06F 17/00

(52) U.S. Cl. 715/249

(57) ABSTRACT

A system and method for robustly editing a page description language of a first format using a familiar page editor for editing page descriptions of a second format is described. Portions of the original page are delimited and the page is then converted to the second format where it can be edited natively and then converted back into the first format. Preserved delimiting information can be used in conjunction with stored reference information to repair problems caused by the processes of converting and editing.

### FIELD OF THE INVENTION

The present invention pertains to page editing and in particular to editing an object-oriented page description format using an editor designed for a different page description format.

### BACKGROUND OF THE INVENTION

Document pages can be represented electronically in a variety of formats. One type of format is the raster image format. Editing a raster image page can be difficult since only simple image pixels can be edited. Another type of format is an object-oriented format including, for example, text, artwork, and image objects. A page of this format usually includes a collection of objects defined by a page description language (PDL). Some PDLs specify objects, their appearance and their relationships through data while other specify them through an executable programming language. Most PDLs are based on an imaging model that governs the display of the objects and includes the concept of a painting order for the objects.

Suppliers of page editor software applications often utilize a PDL that is unique to their application and may be referred to as a native PDL or native file format. Even from the same supplier, a variety of native PDLs may be used for different types of pages. For example, Adobe® InDesign® and Adobe® Illustrator® each utilize different native PDL formats for respectively editing general purpose documents and artwork.

Interchange of documents between editors and other software applications is desirable and can be accomplished, for example, by conversion tools, embedded application links and interchange PDLs. Input conversion tools allow a page editor to open a foreign PDL and convert it to native PDL so that it can be edited. Output conversion tools enable a native PDL to be converted to a foreign PDL for use by foreign application. Conversion tools may not always produce the desired results. For example, a conversion tool may be incomplete and be unable to fully support one or both of the PDLs. As another example, the PDLs may have disjoint capabilities and a converter may not be able to properly represent one PDL object with another PDL. As another example, applications may make different assumptions about the use of a PDL so that PDL produced by one application is not suitable for another application. As another example, conversion tools may simply not operate correctly.

One way of overcoming conversion tool problems is to allow foreign PDL to be embedded in a native PDL and allow an edit request of the foreign PDL to be processed by an application that treats the embedded PDL as native. An example of this is the object linking and embedding (OLE) technology. Applications supporting embedded foreign PDL typically need to provide some mechanism for rendering the foreign PDL for display.

Another way of overcoming conversion tool problems is to develop a third PDL format that is widely adopted as an interchange format. Adobe® PostScript and Adobe® PDF are examples of such interchange formats. However, some of the problems of conversion can still remain, such as inconsistent use of the PDL between applications.

Some interchange formats were originally intended to be produced by conversion from a native PDL and consumed by a display application such as a printer or a computer display viewer. Initially, page editors for these interchange PDLs were not seen as necessary. However, a need for at least rudimentary editor capabilities was soon identified and viewers developed limited page editing capabilities. The use of interchange PDLs in commercial printing operations has increased the demand for more sophisticated editor functionality since a printer may not have access to the native PDL used to produce the interchange PDL. Further, printers typically expend significant resources in a prepress process modifying an early version of the interchange PDL to suit an intended printing process. Thus, when a need to change a later version of PDL is identified, editing of the later version becomes essential.

Some suppliers have responded to this need by providing stand-alone interchange PDL editors. These editors can be relatively expensive in part to recoup the significant costs involved in developing a fully featured editor and in part because of the value they bring to some customers. However, they tend to be too expensive for a printer or end user that needs only to make corrections to a few objects on the occasional page.

Some suppliers have responded by providing input conversion tools for the interchange PDL. As an example, Adobe® Illustrator® can import a PDF page which may have been produced by Illustrator® or some other application. PDF objects can be converted to Illustrator objects if compatible. PDF objects that are not compatible with Illustrator may be converted to a special Illustrator object. This so-called non-native object can include a portion of PDF corresponding to the incompatible PDF object so that the object can at least be rendered for display by Illustrator. After editing native PDL, Illustrator can save the resulting page as PDF PDL which can involve conversion of illustrator objects to PDF objects and extraction of PDF portions associated with non-native objects.

However, roundtrip editing of an interchange PDL using a foreign PDL editor and it's input and output conversion tools can suffer some of the conversion problems described above. In particular, a prepress system may have processed interchange PDL in a way that needs to be preserved so that downstream processing by the prepress system or other systems can occur properly. As an example, the prepress system may have introduced and/or modified objects as part of a trapping, color management or management process in a manner that the foreign PDL editor will not preserve. In addition, extraction of PDF portions associated with non-native objects can involve an incomplete extraction (e.g. marks or tags associated with PDF objects may not be preserved).

Thus, a need exists for a cost-effective but comprehensive and robust method for editing pages defined by an interchange PDL.

### SUMMARY OF THE INVENTION

The present invention provides a system and method for robust editing of a page defined by a first PDL format using a familiar page editor defined for editing pages defined by a second PDL format. Native editing of foreign page content can occur by converting to/from the native format but can result in unexpected changes to the appearance or metadata associated with the original content.

According to one aspect of the invention, the original page is divided into PDL portions with each portion defining one or more graphic objects displaying in order. Delimiting information is added to each PDL portion to form delimited portions of the first PDL format. Delimiting information preferably includes a portion identifier, identifying a delimited portion of PDL. Delimiting information is preferably invisible, when the PDL is rendered, so that the page appears as intended when displayed. Delimiting information must also be preservable throughout the editing process.

According to another aspect of the invention, reference information is stored for later use based on the delimited portions. This can include, for example, metadata related to objects defined by the portions and/or original portions of the first PDL format for each portion.

According to another aspect of the invention, the page, including delimiting information, is then converted to the second PDL format with each delimited portion of first PDL associated with and represented by a so-called non-native object. Displaying a non-native object in the editor can be accomplished by rendering the corresponding portion of first PDL.

According to another aspect of the invention, a non-native object may be edited by a user using a subset of functions provided by a second PDL format editor. For example, a non-native object may be moved, resized, rotated and/or have certain attributes set or changed. In general, the subset of editing functions must be transferable to the associated portion of first PDL.

According to another aspect of the invention, a non-native object may be fully edited by converting it to one or more native objects which have a similar appearance when displayed. Delimiting information, associated with the non-native object, must be preserved in association with the corresponding native objects. The user can then edit the native objects to achieve the desired result using the second PDL format editor.

According to another aspect of the invention, overt user edits of non-native objects can be detected by a variety of means. This information may be presented to a user and/or used when automatically processing an object.

According to another aspect of the invention, when editing is completed, the edited page based on the second PDL format, is converted back into the first PDL format. Preserved delimiting information in the edited page can be used to correlate reference information for a portion with an edited portion of first PDL.

According to another aspect of the invention, processing of the edited first PDL can then be performed to result in a robustly edited page. Missing or damaged metadata in an edited portion can be added or repaired accordingly. Edited portions that were inadvertently modified by the process can be similarly repaired or replaced with reference information. Delimiting information may finally be removed at the end of the process.

These and other aspects of the present invention are illustrated in the detailed description of the invention.

### BRIEF DESCRIPTION OF THE DRAWINGS

FIG. 1 is a diagram illustrating an exemplary first PDL page editor according to the present invention.

FIG. 2 is a diagram illustrating an exemplary first PDL (original PDF) page 1 according to the present invention.

FIG. 3 is a diagram illustrating an exemplary delimited first PDL page according to one embodiment of the present invention.

FIG. 4 is a diagram illustrating an exemplary reference first PDL page according to one embodiment of the present invention.

FIG. 5 is a diagram illustrating an exemplary second PDL page according to one embodiment of the present invention.

FIG. 6 is a diagram illustrating an exemplary edited second PDL page according to one embodiment of the present invention.

FIG. 7 is a diagram illustrating an exemplary edited first PDL page according to one embodiment of the present invention.

FIG. 8 is a diagram illustrating an exemplary robustly edited first PDL page according to one embodiment of the present invention.

### DETAILED DESCRIPTION OF THE INVENTION

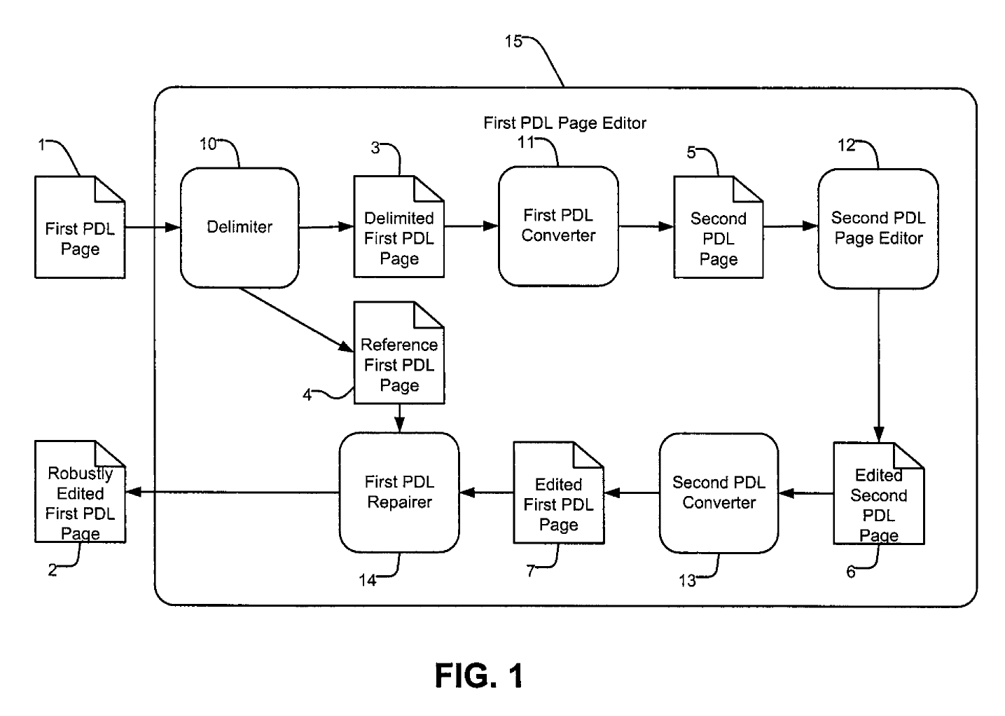

FIG. 1 is a diagram illustrating an exemplary first PDL page editor 15 according to the present invention. Computerized first PDL page editor 15 can access a first PDL page 1 and provide a display of graphic objects represented by first PDL page 1. A user, with first PDL page editor 15, can select displayed graphic objects and make modifications to them as desired. The user can then save the result as robustly edited first PDL page 2. Both first PDL page 1 and robustly edited first PDL page 2 are based on a first PDL format.

In this application, a robustly edited PDL means that a portion of original PDL, of a first PDL format and representing at least one graphic object, is substantially unmodified in the edited version of the page unless the user overtly modifies the portion of original PDL. Substantially unmodified means that the portions are identical or differ in a manner that is not visibly discernable by a user when the portions are rendered. Robustly edited PDL also means that certain attributes of a portion of original PDL are preserved even if the user overtly modifies the portion of original PDL. Robust editing may be required to compensate for problems caused by second PDL page editor 12, which is an editor designed to edit pages defined by a second PDL format that is different from the first PDL format.

In one preferred embodiment, first PDL page editor 15 is provided as part of a printing workflow system used to prepare customer files for printing. The workflow system may have performed a number of processing steps prior to production of first PDL page 1, including, for example, preflight, image substitution (OPI), color management, and trapping. Workflow processes can alter earlier revisions of first PDL page 1 to facilitate further processing of first PDL page 1. Alterations can include, for example, altering attributes of PDL representing graphic objects, adding PDL representing new graphic objects (e.g. trap objects), and/or removing PDL representing graphic objects (e.g. redundant objects). Workflow processes can also add attributes to first PDL first PDL page 1 in association with graphic objects. Added attributes can, for example, be used to uniquely identify graphic objects. As additional examples, added attributes can be used to associate objects to one another or to associate objects with other entities, such as display layers. Any number of attributes may be added, in association with graphic objects, to first PDL page 1 or externally to first PDL page 1 so that downstream processing of robustly edited first PDL page 2 behaves as desired.

In a workflow system embodiment, a user can submit a request to edit first PDL page 1 to first PDL page editor 15. A workflow system server, associated with first PDL page editor 15, accesses first PDL page 1 and provides it to delimiter 10 which produces delimited first PDL page 3 and reference first PDL page 4. Delimited first PDL page 3 and reference first PDL page 4 are preferably based on the first PDL format too and include original first PDL from first PDL page 1.

Delimiter 10 adds delimiting information to delimited first PDL page 3 that enables identification of portions of first PDL that correspond to at least one graphic object in first PDL page 1. A delimited portion of first PDL in delimited first PDL page 3 can represent one or more graphic objects. In a preferred embodiment, delimiter 10 parses first PDL from first PDL page 1 to identify graphic objects in a display order. Delimiter 10 then determines, either automatically or based on user input, which graphic objects to delimit. In some embodiments, each graphic object is delimited. In other embodiments where only localized edits are to be performed, performance may be enhanced by delimiting a number of graphic objects that paint consecutively and are related somehow (e.g. already grouped, or associated with the same layer or painting in a region of the page).

Reference first PDL page 4, discussed in more detail below, can be created by delimiter 10 as a reference for first PDL page 1, based on delimiting information added to delimited first PDL page 3. Reference first PDL page 4 can be used for detecting problems caused by the foreign editing process.

The server can then produce second PDL page 5 from delimited first PDL page 3 using first PDL converter 11. Second PDL page 5 is based on a second PDL format. First PDL converter 11 converts each delimited portion of first PDL from delimited first PDL page 3 into a corresponding portion of second PDL. Each portion of second PDL corresponds to a so-called non-native graphic object. A non-native graphic object is an object, defined by the second PDL format, that can correctly render the appearance of the corresponding portion of first PDL in the display of second PDL page editor 12 but whose editability is restricted by second PDL page editor 12. For example, the portion of second PDL can include or reference a rendering of the corresponding portion of first PDL. In preferred embodiments, a non-native object can be associated with the corresponding portion of first PDL so that a rendering of the first PDL can be dynamically presented in the display of second PDL page editor 12. For example, a portion of second PDL for a non-native object can include the corresponding portion of first PDL. As another example, the portion of second PDL can reference information related to the portion of first PDL.

In addition to producing non-native graphic objects that preserve original appearance, first PDL converter 11 must produce portions of second PDL that preserve delimiting information present in the corresponding delimited portion of first PDL. A detailed example below clarifies this.

Second PDL page editor 12 may provide rudimentary native editing capabilities for non-native objects. For example, second PDL page editor 12 may be able to configure a portion of second PDL for a non-native graphic object to effect a coordinate transformation on the object in the display of second PDL page editor 12 (display order change). As another example, rudimentary native editing capabilities may include transparency editing and altering an object in the display order. To be useful, a rudimentary edit of a non-native object must be applied to the corresponding portion of first PDL subsequently produced when conversion from second PDL format to first PDL format occurs.

In preferred embodiments, a user can select a non-native object in the display of second PDL page editor 12 and request conversion of the associated delimited portion of first PDL into a portion of second PDL representing one or more native objects that can be fully edited by second PDL page editor 12. For many types of objects that are represented consistently by both PDL formats, the built-in converter of second PDL page editor 12 may suffice. For non-native objects where a built-in converter is inadequate, a variation on first PDL converter 11 can be provided to ensure that native objects produced are visually equivalent to the non-native object and include delimiting information. The variation on first PDL converter 11 can be configured to automatically convert selected portions of first PDL directly into native objects as part of the conversion from delimited first PDL page 3 to second PDL page 5. As another alternative, the variation on first PDL converter 11 can be provided as a plug-in module that operates on a selected non-native object of second PDL page 5.

After the editing process is complete, second PDL page editor 12 saves the result as edited second PDL page 6. Then, second PDL converter 13 converts edited second PDL page 6 back to the first PDL format as edited first PDL page 7. In a preferred embodiment, second PDL converter 13 can be a built-in converter provided with second PDL page editor 12. In other embodiments, second PDL converter 13 can be a plug-in converter or a converter operating on the workflow server.

Finally, first PDL page editor 15 completes the production of robustly edited first PDL page 2 by comparing aspects of edited first PDL page 7 with reference first PDL page 4. In general, first PDL repairer 14 produces robustly edited first PDL page 2 by ensuring that unedited portions of first PDL from first PDL page 1 are preserved in robustly edited first PDL page 2. These portions can be extracted from reference first PDL page 4 or from edited first PDL page 7. First PDL repairer 14 also ensures that certain attributes, associated with an object defined by first PDL page 1, are preserved in robustly edited first PDL page 2, even if the corresponding object in second PDL page 5 was overtly edited by second PDL page editor 12.

In one preferred embodiment, first PDL page editor 15 can accomplish this by ensuring that each delimited portion of first PDL in delimited first PDL page 3 is uniquely identifiable (e.g. delimiting information including portion identifiers). First PDL in reference first PDL page 4 can thus be configured so that graphic objects are associated with portion identifiers corresponding to those in delimited first PDL page 3. Thus graphic objects in reference first PDL page 4 can be correlated with unmodified or modified graphic objects in edited first PDL page 7. This is clarified, by example, below.

In another embodiment, first PDL page editor 15 can be provided as a standalone editor operating on a client computer that hosts second PDL page editor 12. In this embodiment, delimiter 10, first PDL converter 11, second PDL converter 13, and first PDL repairer 14 can be provided as plug-in modules to second PDL page editor 12.

In order to provide a more detailed understanding of the present invention, an example of one preferred embodiment in the context of an exemplary first PDL page 1 is described. In this example, the first PDL format is the Adobe® PDF format, the second PDL format is the Adobe® Illustrator format, and second PDL page editor 12 is the Adobe® Illustrator® software application. Illustrator® includes built-in PDF converters but these converters are inadequate for some examples of PDF that we encounter in our workflow systems. As an example, Illustrator does not fully support Device-N color spaces and graphic objects defined by such a color space are converted to an approximating CMYK color space. First PDL converter 11 can be configured, for example, to create a group of N objects, each with a single colorant, to more faithfully represent the original object.

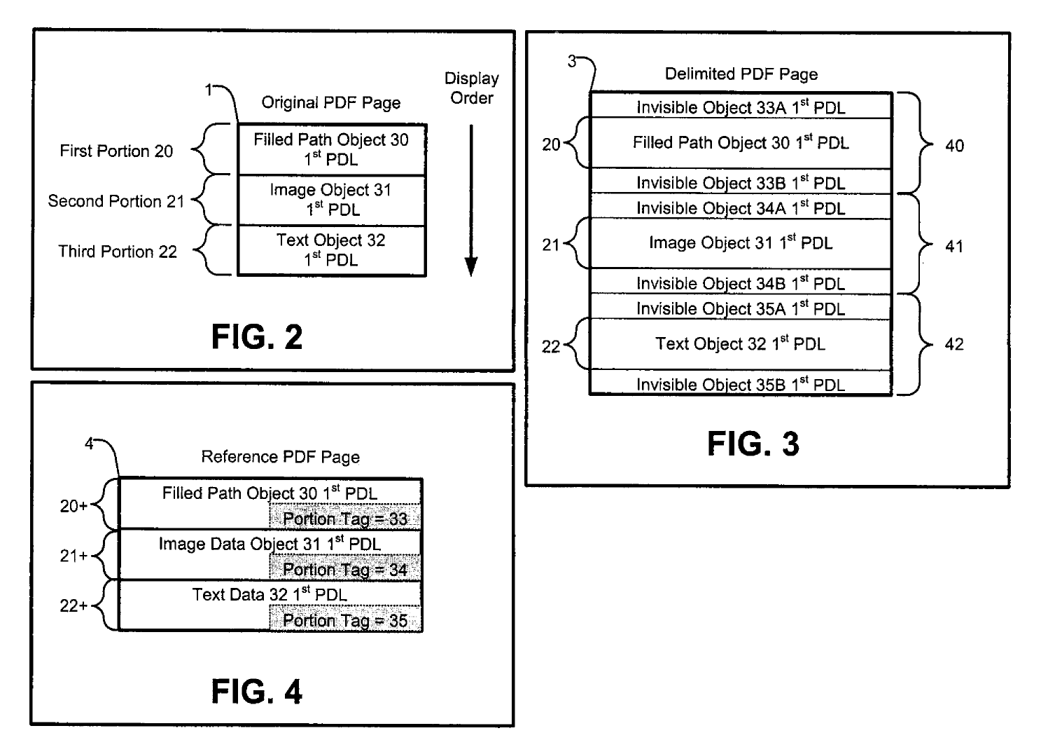

FIG. 2 is a diagram illustrating an exemplary first PDL (original PDF) page 1 according to the present invention. In this example, delimiter 10 has identified three PDF portions 20-22. First PDF portion 20 defines a filled path object 30, second PDF portion 21 defines an image object 31, and third PDF portion 22 defines a text object 32. Filled path object 30 is defined to paint first, followed by image object 31 and text object 32. In some cases, portions of PDF portions 20-22 may not be contiguously defined as illustrated but can be reconstructed as such by parsing the first PDL to identify objects 30-32 and then recreating contiguous PDF portions 20-22, as illustrated, which equivalently represent objects 30-32.

In addition to defining graphic objects, PDF portions can include metadata about those objects. Different types of metadata can be included and/or associated with a PDF portion. Exemplary types of metadata include identifying data, relationship data and other metadata. Identifying data may be produced, for example, by a trapping function so that each object that may be the subject of a trap function can be uniquely referenced. Relationship data may also be created by a trap function wherein a trap object is created at the boundary of two or more objects and the trap relationship between those objects needs to be retained. Examples of other metadata can include layer associations for an object and screening requirements for an object.

FIG. 3 is a diagram illustrating an exemplary delimited first PDL (PDF) page 3 according to one embodiment of the present invention. According to one embodiment, delimiter 10 envelopes each portion of PDF language identified with additional PDF language defining invisible objects to form delimited portions of PDF. For example, first PDF portion 20, defining filled path object 30, is enveloped by PDF defining invisible objects 33A and 33B to form delimited PDF portion 40. According to one embodiment, invisible objects are defined as image objects with image values encoding information relevant to the editing process. These image objects can be made invisible by configuring an associated fill mask appropriately. Further, these invisible image objects can be configured in such a manner that restricted edits, made by second PDL page editor 12, can be easily identified. For example, these image objects can be positioned at the page origin and have the same coordinate transform as the page and be as large as the page, and be configured to paint opaquely. Thus, any restricted edit may be detected by a change in a delimiting object.

Invisible objects 33-35 can be assigned a unique identifier for the corresponding portion of PDF and be tagged accordingly. For example, invisible objects 33A and 33B can be assigned a unique identifier (e.g. id=33) and this value can be encoded in the image pixel data. Similarly, invisible objects 34A, 34B, 35A, and 35B can respectively be tagged with unique identifier values of 34A, 34B and 35A, 35B for their corresponding portions of PDF. Different types of invisible objects can be utilized and different portion identification schemes can be utilized.

FIG. 4 is a diagram illustrating an exemplary reference first PDL (PDF) page 4 according to one embodiment of the present invention. Reference first PDL page 4 is created by delimiter 10 based on original first PDL page 1 and portion identifiers. Delimiter 10 can, for example, tag reference PDF portions 20+, 21+ and 22+ with portion identifiers as shown or can associate the portion identifiers with the portions through some other means.

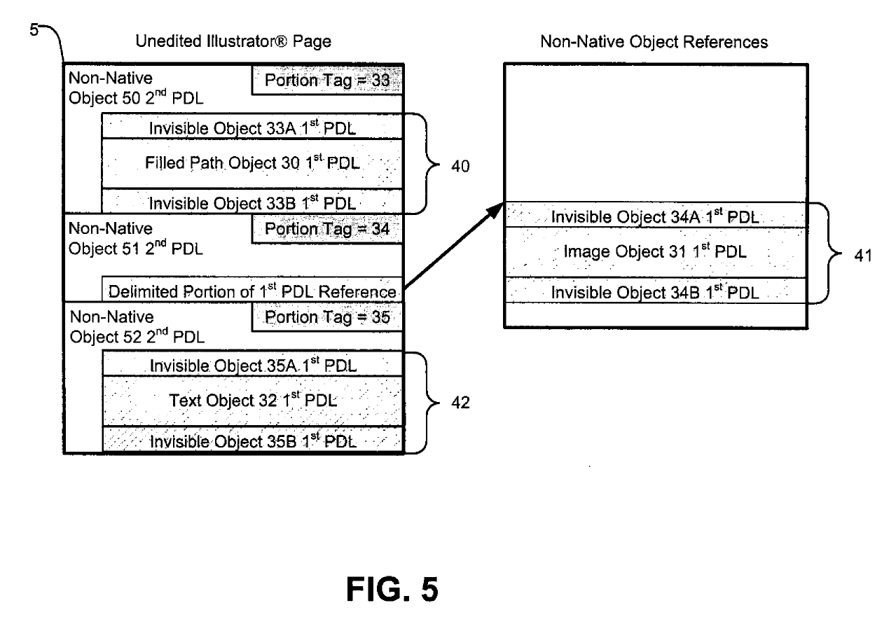

FIG. 5 is a diagram illustrating an exemplary second PDL (Illustrator®) page 5 according to one embodiment of the present invention. First PDL converter 11 created, for example, three portions of second PDL for non-native objects 50-52 to represent PDF portions 20-22. PDF portions can be embedded or referenced by non-native objects. Non-native objects 50 and 52, for example, depict a case where delimited PDF portions 40 and 42, respectively, are embedded in the Illustrator® page description for non-native objects 50 and 52. Non-native object 51, as another example, externally references delimited PDF portion 41. It may be advantageous, for performance or other reasons, to store delimited portions of first PDL external to second PDL page 5.

Note that in one preferred embodiment, each non-native object 50-52 is tagged with corresponding portion identifiers. This can be done, for example, to more easily identify a portion in the context of second PDL page editor 12 by reading a second PDL tag rather than decoding a portion identifier from associated first PDL.

In another preferred embodiment, certain types of first PDL objects, when processed by first PDL converter 11, can be converted to native second PDL objects directly. These so-called “safe” first PDL objects are ones whose second PDL representations can be tagged with portion identifiers that will survive processing by second PDL page editor 12 and second PDL converter 13. As an example, in the case of images objects in PDF, converting them to a native Illustrator® image object referencing a Photoshop®-compatible image PDL can be performed when producing second PDL page 5. Since Illustrator® supports Photoshop® editing of image objects and the portion identifier tags created have experimentally been found to survive round-trip editing, the user experience may be improved. A checksum on data for image object 31 can be calculated and tagged in the corresponding native object as another means for detecting an inadvertent or overt edit.

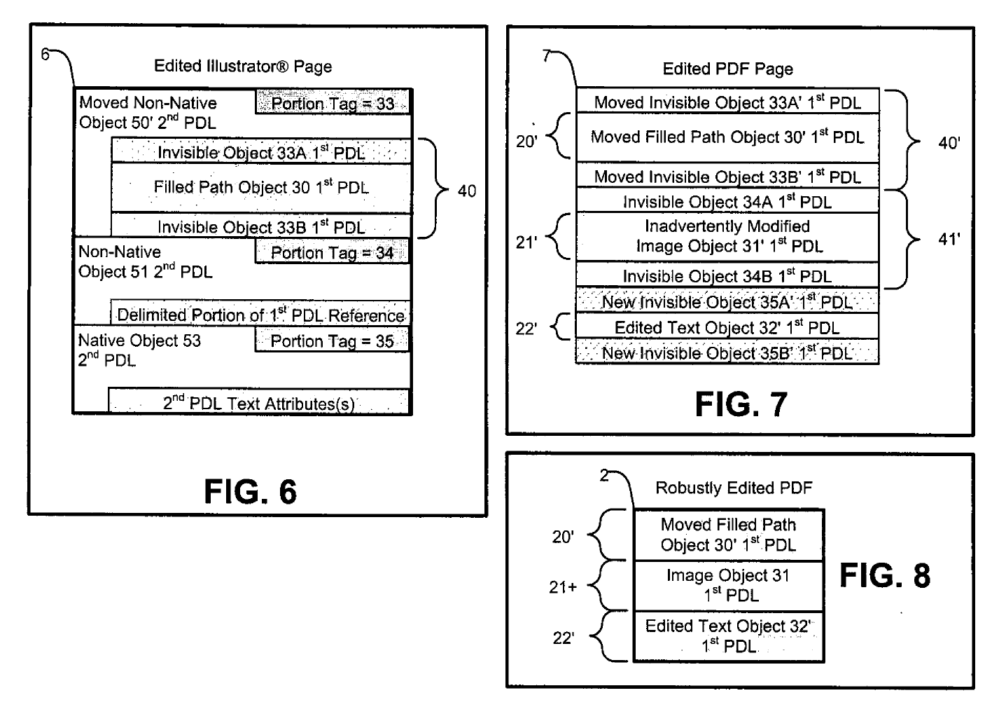

FIG. 6 is a diagram illustrating an exemplary edited second PDL (Illustrator®) page 6 according to one embodiment of the present invention. In this example, assume that a user, using second PDL page editor 12, has moved non-native object 50 to a different position in edited second PDL page 6 (now represented as non-native object 50′). The display of non-native object 50 in second PDL page editor 12 can be updated to moved non-native object 50′ by repositioning the rendering of delimited PDF portion 40 to give the correct visual appearance. Assume also, that no overt edit of non-native object 51 occurred. Overt edits can be tracked, for example, by making a detectable change to a portion identifier. As an example, two-part portion identifiers can be utilized where the first part is invariant and the second part is changed when an edit is made. As another alternative, overt edits can be detected by changing the representation of portion identifiers during conversion back to first PDL by second PDL converter 13, as described below.

Further assume that a user has selected non-native object 52 and requested that second PDL page editor 12 convert it to native Illustrator® format using an Illustrator® plug-in module. The plug-in module, in this case has created native text object 53 including one or more Illustrator® text attributes to initially correspond with original text object 32. The module also preserves the portion identifier tag (e.g. id=35, corresponding to third PDF portion 22), with native object 53. If, multiple native objects were created for a portion, each would be associated with the portion identifier accordingly. Finally, the user may have performed one or more native editing functions using second PDL page editor 12 on native object 53.

FIG. 7 is a diagram illustrating an exemplary edited first PDL (PDF) page 7, produced according to one embodiment of the present invention. In this example, PDF portions that have been overtly or inadvertently modified are depicted with a lightly shaded background. In this example, second PDL converter 13, which may have been supplied with second PDL page editor 12, has converted edited second PDL (Illustrator®) page 6 into edited first PDL (PDF) page 7. Second PDL converter 13 must be able to apply an appropriate coordinate transform to delimited PDF portion 40 to correspond with the movement of non-native object 50 requested by the user. This results, for example, in a modified delimited PDF portion 40′ where each associated moved invisible object 33A′, modified filled path object 30′, and moved invisible object 33B′ have been moved accordingly.

Assume that second PDL page editor 12 or second PDL converter 13 has inadvertently modified first PDF portion 20 during the conversion process so that in effect an inadvertently modified image object 31′ is now included in modified delimited PDF portion 41′. Note that in this example, second PDL converter 13 reproduced invisible objects 34A and 34B without modification. The invention is still useful if these inadvertent edits are applied to invisible objects, so long as certain properties (e.g. those encoding portion identifiers and visibility) remain unaffected.

Assume further that second PDL converter 13 has successfully converted Illustrator® language for native object 53 into PDF language corresponding to modified PDF portion 22′. It is important here that second PDL converter 13 preserve portion identifier information (e.g. id=35) for each object defined by modified PDF portion 22′. If extensive edits occurred, modified PDF portion 22′ may bear little resemblance to original third PDF portion 22.

In a preferred embodiment, as shown, second PDL converter 13 creates new delimiting invisible objects for native second PDL objects encountered. The delimiting objects must include a portion identifier corresponding to the native object(s). The representation of portion identifiers can either be with the original representation (e.g. encoded in image data values) or with a new representation (e.g. first PDL tags). A different representation can, for example, be used to signify an overt edit and/or a potentially overt edit of “safe” objects.

In alternative embodiments, delimiting objects can be omitted and a portion identifier can be included as a tag in edited text object 32′.

FIG. 8 is a diagram illustrating an exemplary robustly edited first PDL (PDF) page 2 according to one embodiment of the present invention. In this example, first PDL repairer 14 has examined edited first PDL page 7 to identify modified delimited PDF portions 40′, 41′, and modified PDF portion 22′. Modified delimited PDF portions 40′ and 41′ can be detected, for example, by identifying invisible objects tagged with portion identifiers. Modified PDF portion 22′, for example, can be detected by identifying portion identifier (id=35) for edited text object 32′ defined by that portion. In a preferred embodiment, modified PDF portion 22′ can be detected from modified delimited PDF portion 42′ based on invisible object 35 associated with new invisible objects 35A′ and 35B′.

In the case of modified delimited PDF portion 40′, portion identifiers may indicate the presence of an overt edit. First PDL repairer 14 can locate reference PDF portion 20+from reference first PDL page 4 based on the similar portion identifier (id=33). Detection of an overt edit can alternatively be based upon comparison of attributes between edited and reference delimiting objects. First PDL repairer 14 can then add or repair any metadata associated with graphic objects defined by modified PDF portion 20′ with metadata from reference PDF portion 20+. Finally, first PDL repairer 14 removes delimiting information (moved invisible objects 33A′ and 33B′) so that modified PDF portion 20′ remains in robustly edited first PDL page 2.

In the case of modified delimited PDF portion 41′, portion identifiers can indicate that no overt edit was made to modified PDF portion 21′. In this case, corresponding reference PDF portion 21+ from reference first PDL page 4 can replace modified PDF portion 21′ in robustly edited first PDL page 2. As another alternative, reference PDF portion 21+ can be used to repair modified PDF portion 21′.

In the case of modified PDF portion 22′, first PDL repairer 14 can use corresponding reference PDF portion 22+ to add or repair any metadata associated with objects defined by modified PDF portion 22′.

In one preferred embodiment, any edited portion of first PDL that retains the original representation of portion identifiers can be automatically replaced with the reference portion of first PDL as this means that either no overt edit occurred or only a restricted edit occurred. In the latter case, the corresponding restricted edit is applied. Any PDL portions for “safe” objects may also be replaced with portions of reference PDL if a means exists to determine an overt edit (e.g. checksum).

First PDL repairer 14 may also compare the number of portions and the number of graphic objects in each portion with information reference first PDL page 4 as a consistency check. If an inconsistency is found, the user can be presented with an indication of the inconsistency. Ideally, this can be portrayed visually (e.g. missing portions displayed or inconsistent versions displayed comparatively). For cases where portions have been overtly added or deleted portions the user may still wish to proceed with robustly edited first PDL page 2.

First PDL repairer 14 may also analyze metadata to determine if any inconsistencies have arisen as a result of an edit. For example, if an object that contributes to a trap object was edited, the related trap object may no longer be valid. First PDL repairer 14, can identify the related trap object and may either be able to repair it, delete it if appropriate, and/or highlight it to a user.

In summary, some basic principles must be observed to ensure a robustly edited first PDL using a second PDL editor according to this invention. First, an object corresponding to a portion of first PDL must be accurately displayable by second PDL page editor 12 in the context of other objects of second PDL page 5. Second, portion identifiers must survive the roundtrip edit.

Regarding the first principle, second PDL page editor 12 may be sufficiently robust to dynamically render a portion of first PDL with the correct shape. If second PDL page editor 12 cannot do this, first PDL converter 11 may need to provide an appropriately shaped rendering of the object for use by second PDL page editor 12. As an example, a triangular shaped path object, defined by a first PDL portion, may be rendered to a rectangular image by second PDL page editor 12 with pixels correctly representing the triangular portion of the path but painting white in surrounding pixels out to the boundary of the image rectangle. These white pixels may occlude background color contributed by other objects. In this case, first PDL converter 11 can supply an image with an appropriately shaped clipping mask to ensure that only relevant pixels are painted.

Regarding the second principle, some systems may preserve tags associated with first PDL portions through the round trip edit (e.g. “safe” objects). For systems that cannot guarantee this, a delimiting scheme, such as the one disclosed above, is required.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the scope of the invention.

### PARTS LIST

1 first PDL page
2 robustly edited first PDL page
3 delimited first PDL page
4 reference first PDL page
5 second PDL page
6 edited second PDL page
7 edited first PDL page
10 delimiter
11 first PDL converter
12 second PDL page editor
13 second PDL converter
14 first PDL repairer
15 first PDL page editor
20 first PDF portion
20+ reference PDF portion
20′ modified PDF portion
21 second PDF portion
21+ reference PDF portion
21′ modified PDF portion
22 third PDF portion
22+ reference PDF portion
22′ modified PDF portion
30 filled path object
30′ modified filled path object
31 image object
31′ inadvertently modified image object
32 text object
32′ edited text object
33 invisible object
33A invisible object
33A′ moved invisible object
33B invisible object
33B′ moved invisible object
34 invisible object
34A invisible object
34B invisible object
35 invisible object
35A invisible object
35A′ new invisible object
35B invisible object
35B′ new invisible object
40 delimited PDF portion
40′ modified delimited PDF portion
41 delimited PDF portion
41′ modified delimited PDF portion
42 delimited PDF portion
42′ modified delimited PDF portion
50 non-native object
50′ moved non-native object
51 non-native object
52 non-native object
53 native object

1. A method for editing a first page description, the method comprising:
identifying a plurality of portions of the first page description wherein the first page description is based upon a first format and wherein a portion of the first page description defines at least one original graphic object;
forming a plurality of delimited portions by adding delimiting information for the plurality of portions to the first page description;
storing reference information derived from the plurality of portions of first page description in association with delimiting information for the plurality of portions of the first page description;
forming a second page description defining a plurality of non-native graphic objects by converting the first page description, wherein a non-native graphic object represents a delimited portion of the plurality of delimited portions and wherein the second page description is based upon a second format;
editing the second page description using a page editor suitable for editing pages defined by the second format wherein editing preserves delimiting information;
forming an edited first page description based on the first format by converting the edited second page description wherein converting preserves delimiting information; and
processing the edited first page description based on the reference information.

2. A method according to claim 1 wherein identifying the plurality of portions of the first page description comprises identifying an ordered list of portions based on a display ordered list of graphic objects defined by the first page description.

3. A method according to claim 1 wherein adding delimiting information for the plurality of portions to the first page description comprises associating an identifier tag with a portion of first page description.

4. A method according to claim 1 wherein adding delimiting information for the plurality of portions comprises inserting at least one delimiting graphic object defined by the first format into each portion of the plurality of portions.

5. A method according to claim 4 wherein inserting a delimiting graphic object comprises inserting a graphic object including at least one attribute that is unlikely to be modified by editing and converting.

6. A method according to claim 5 wherein inserting a delimiting graphic object comprises inserting a delimiting graphic object that is invisible when rendered.

7. A method according to claim 6 wherein forming a delimited portion comprises:
inserting a first delimiting graphic object to display before the at least one graphic object defined by the portion of first page description;
inserting a second delimiting graphic object to display after the at least one graphic object defined by the portion of first page description; and
associating a portion identifier with the delimiting graphic objects.

8. A method according to claim 1 wherein storing reference information comprises storing a copy of the portion of first page description.

9. A method according to claim 1 wherein storing reference information comprises storing metadata associated with the at least one graphic object defined by the portion of first page description.

10. A method according to claim 9 wherein storing metadata comprises storing metadata of a plurality of metadata types.

11. A method according to claim 10 wherein the plurality of metadata types comprises object identifiers, trap processing information, color processing information, screening information and layer information.

12. A method according to claim 1 wherein converting the first page description comprises, for each non-native object, associating the corresponding delimited portion of the first page description with the non-native graphic object.

13. A method according to claim 12 wherein a non-native graphic object comprises a graphic object that is eligible for a subset of editing functions provided by the page editor.

14. A method according to claim 13 wherein the subset of editing functions includes coordinate transformation editing, transparency editing, and display order.

15. A method according to claim 12 wherein editing the second page description comprises displaying a non-native graphic object by rendering a part of the associated delimited portion of first page description.

16. A method according to claim 12 where editing the second page description comprises:
replacing a selected non-native graphic object with at least one native graphic object by converting the delimited portion of the first page description associated with the non-native graphic object; and
associating the at least one native graphic object with delimiting information that is associated with the selected non-native graphic object.

17. A method according to claim 12 wherein editing the second page description comprises:
editing a graphic object using editing functions provided by the page editor; and
altering information associated with the graphic object to indicate that the corresponding portion of first page content has been overtly edited.

18. A method according to claim 17 wherein converting the edited second page description comprises converting a non-native graphic object by supplying the delimited portion of the first page description that is associated with the non-native graphic object.

19. A method according to claim 18 wherein supplying includes applying edits made to the non-native graphic object to the first page description supplied wherein the non-native graphic object was overtly edited.

20. A method according to claim 17 wherein converting the edited second page description comprises:
selecting native graphic objects;
supplying at least one graphic object defined by the first format to represent a selected native graphic object wherein a rendering of the at least one graphic object is substantially the same as a rendering of the selected native graphic objects; and
delimiting the at one least graphic object defined by the first format with delimiting information associated with the selected native graphic object.

21. A method according to claim 20 wherein delimiting the at least one graphic object defined by the first format comprises:
inserting a first delimiting graphic object to display before the at least one graphic object;
inserting a second delimiting graphic object to display after the at least one graphic object; and
associating a portion identifier with the delimiting graphic objects.

22. A method according to claim 20 wherein delimiting the at least one graphic object defined by the first format comprises associating a portion identifier with the at least one graphic object.

23. A method according to claim 1 wherein processing the edited first page description based on the reference information comprises identifying portions of the edited first page description based on preserved delimiting information.

24. A method according to claim 23 including repairing an edited portion based on reference information identified by delimiting information preserved in the edited portion.

25. A method according to claim 23 including replacing an edited portion with reference information identified by delimiting information preserved in the edited portion.

26. A method according to claim 23 comprising removing delimiting information from the edited first page description to form robustly edited first page description.

27. A system for editing a first page description, the system comprising:
a delimiter operative to:
identify a plurality of portions of the first page description wherein the first page description is based upon a first format and wherein a portion of the first page description defines at least one original graphic object;
form a plurality of delimited portions by adding delimiting information for the plurality of portions to the first page description;
store reference information derived from a portion of first page description in association with delimiting information for the portion;
a first format converter operative to form a second page description defining a plurality of non-native graphic objects by converting the first page description, wherein a non-native graphic object represents a delimited portion of the plurality of delimited portions and wherein the second page description is based upon a second format;
a second format editor operative to edit the second page description using a page editor suitable for editing pages defined by the second format wherein editing preserves delimiting information;
a second format converter operative to forming an edited first page description based on the first format by converting the edited second page description wherein converting preserves delimiting information; and
a first format repairer operative to process the edited first page description based on the reference information.

28. A medium carrying a set of computer-readable signals comprising instructions which, when executed by a data processor, cause the data processor to execute a method according to claim 1.
